(19) United States
(12) Patent Application Publication
(10) Pub. No.: US 2006/0092044 A1
(43) Pub. Date: May 4, 2006

(54) Traffic light and method of traffic control with the traffic light

(76) Inventor: Oleg Naljotov, Brooklyn, NY (US)

Correspondence Address: Oleg Naljotov, Apt. 5D, 3130 Brighton 6th Street, Brooklyn, NY, 11235, US

(21) Appl. No.: 11/303,215

(22) Filed: Dec. 16, 2005

Related U.S. Application Data
(63) Continuation-in-part of application No. 10/826,217, filed on Apr. 17, 2004.
Application No. 10/826,217 is a continuation-in-part of application No. 09/844,746, filed on May 8, 2002, now abandoned.

(51) Int. Cl. G08G 1/095

(52) U.S. Cl. 340/907

(57) ABSTRACT

A traffic light device is provided, comprising green, yellow, and red light displays, wherein the yellow light display has a capability to advise the motorist on the time remaining to the end of the yellow signal, and accordingly to the beginning of the red signal, in the form of numerals, exhibited on the face of the yellow light display during the time of illumination of the yellow signal, and corresponding to the number of seconds remaining to the end of the yellow signal. The yellow light display is generally connected to a countdown unit, controlling the sequential displaying of said numerals, which provides aforesaid capability. A general switching control device controls the countdown unit, particularly supplying to the countdown unit signals specifying the time period during which the yellow light must be displayed. This traffic light device's capability increases safety of driving, and may save people's lives and health.

### CROSS REFERENCE TO RELATED APPLICATIONS

This U.S. patent application is a continuation-in-part application of a U.S. patent application Ser. No. 10/826,217, which is a continuation-in-part application of a U.S. patent application Ser. No. 09/844,746 that is being abandoned upon the filing of this application.

### BACKGROUND OF THE INVENTION

The present invention relates to traffic lights and traffic control and can be used on roads which have a traffic light for traffic control.

Traffic lights are known and widely utilized. A conventional traffic light is formed as a device in which successively a green signal is turned on, then a yellow (or orange, or amber) signal is turned on, and then a red signal is turned on, to signal to pedestrians and motorists correspondingly; when the green signal is turned on, traffic is allowed to proceed, when the red signal is turned on it is not allowed to proceed, and when the yellow signal is turned on, next a red signal will follow.

The prior art presents a vast variety of traffic light devices. In particular, U.S. Pat. No. 4,908,616 to Walker describes a conventional red-yellow-green street light assembly supplemented by a flushing green light signal preceding the actuation of the regular green light. The patent teaches that normally a yellow light is displayed after the green light interval and before the red light interval for the purpose of warning motorists that only a limited time remains to traverse the intersection before cross traffic will be permitted to go. The yellow light is normally long enough to permit motorists either clear the intersection or stop before entering the intersection. If a motorist is very near the intersection when the yellow signal appears, he can probably traverse the intersection at normal traffic speed. If the motorist is some distance from the intersection at the beginning of the yellow light interval, a stop is indicated.

A dilemma zone exists at a distance from the intersection whereat upon actuation of the yellow signal, the motorist could conceivably either stop before the intersection or proceed through it before the red light interval. Upon encountering a yellow signal in the dilemma zone, a motorist must decide in a few seconds or less whether to proceed or stop. The ability to stop or proceed on the yellow light is affected by the following in general casual, factors: the driver's reaction time; the vehicle's breaking performance; the speed of the vehicle; the vehicle's acceleration performance; the road surface coefficient of friction; the road grade (incline, flat, decline); the distance from the intersection. All these factors must be quickly taken into account and a proper “clear-stop” decision reached to avoid an unsuccessful stop or clearing the intersection.

Basically, U.S. Pat. No. 4,908,616 proposes a system including an intersection signal four-lights assembly (red, yellow, green, flushing green) and a pre-intersection signal light located adjacent to a reaction point associated with an approach lane. The flushing green light may be operating at least partly concurrently with the green light interval, or corresponding to the near-from-intersection or remote-from-intersection road or traffic conditions. The location of the above-mentioned reaction point is calculated based on a formula, though, as admitted by the inventor, should be regarded as guidelines only. In the reality, the reaction point's location may be determined empirically and may take into account particular conditions of traffic, installation, and traffic objectives. However, considering the aforesaid casual factors, the true reaction point will be different for each particular driver, vehicle, road and traffic conditions, etc. Therefore, it should be hardly expected that the system, described in said patent, would significantly improve the safety on the roads.

Similarly to the previous, another U.S. Pat. No. 4,200,860 to Fritzinger provides for intermittently blinking the traffic control signals to inform motorists and pedestrians at the intervals during each period the lights are red or green as to the time remaining before the lights are changed to green or red to indicate a change in direction of traffic. It's different from the previous one in that it provides changing the frequency of blinking depending on the time remaining until the next light will be switched on. In this aspect it may supply more information to the driver as to making the clear-stop decision.

Another traffic light improvement is disclosed in U.S. Pat. No. 5,986,576 to Armstrong, which teaches a remote portable traffic control signaling device (primarily for control of traffic movement in emergency conditions), and a plurality of warning flashers, including a pair of high luminous light emitting diodes (LEDs), which warning flashers are positioned at a predetermined distance from the portable signaling device to warn passerby of the presence of such portable signaling device.

The prior art also contains U.S. Pat. No. 6,310,562 B1 to Safronov teaching a method of indicating time remaining until traffic lights change. There are provided three green and three red lights suspended in a single horizontal row on both sides of an orange light. They are controlled by a sophisticated and complicated system using “appropriately selected number of traffic signal lamps and an interval of their flushing”. This is another attempt to provide drivers and pedestrians with information on the clear-stop decision.

The next step in the direction of traffic lights improvement is taken in a patent application publication U.S. 2002/0005790 A1 by Georgalis. It discloses an attachment for a standard traffic light assembly functioning as a precise, real-time, numerically displayed count-down device indicating the exact-moment of change from the green to the amber (yellow) signal. This U.S. patent application publication is hereby entirely incorporated by reference. The invention according to U.S. 2002/0005790 A1 may utilize LEDs for visual transmission of pre-determined numerals e.g. 5 through 1 in a LED count-down display. The heat and light produced by the LED display would illuminate translucent semi-conductor materials, such as Gallium Phosphide, to provide current and emitted light for a typical seven segment LED numerical display. Light pipes would be employed so to enlarge the lighted surface. A segmented fluorescent display may also be optionally used according to that invention.

Close to the foregoing U.S. 2002/0005790 A1, U.S. Pat. No. 6,268,805 B1, also hereby entirely incorporated by reference, teaches a traditional three-light traffic control signal assembly, supplemented by a count-down indicator, mounted nearby, with a digital display that displays the remaining time in seconds until the next signal change occurs. The digital display matches the color of the digits being displayed to that of the illumined light of the signal assembly. The system is also capable, relying on traffic sensors, to change this remaining time parameter while informing the driver about the change by means of a flushing caution light.

While the structural arrangements of the above described and many other devices, at first appearance, have similarities with the present invention, they differ in material respects. These differences, which will be described hereinafter, are essential for the effective use of the invention and which admit of the advantages that are not available with the prior art devices and methods.

### BRIEF SUMMARY OF THE INVENTION

Thus, having analyzed the pertaining prior art items, presently known to applicant, it is believed that they all have at least one of three problems. Firstly, they supply information primarily intended for use by the driver in making a clear-stop decision that is determining whether to stop on the green light or to proceed. This invention, however, based on the envision, that another kind of decision may be involved, which is herein named as a “how-to-stop” decision. It derives from the fact that some drivers in different situations, for a number of reasons, may miss their reaction point and, approaching the intersection on the yellow light, be faced with another dilemma: how fast to make a stop. The how-to-stop decision is also affected by similar factors discussed herein before.

Distinctly from the clear-stop decision, the person making a how-to-stop decision urgently needs information about the time remaining to the end of the yellow light, since entering the intersection on the red light, immediately following the yellow light, is strictly prohibited. Except U.S. Pat. No. 6,268,805 B1 mentioned earlier (though not addressing the how-to-stop decision directly), there is no teaching (at least currently known to applicant) on how to inform the driver of the remaining yellow light time. Nevertheless, this information may be crucial to affect his/her way of braking force application, i.e. intenseness and time of the vehicle deceleration, and therefore the road safety.

The second problem present in the prior art is the way of displaying the remaining time information in the known existing devices and methods. The reader looking through the mentioned above pieces of prior art may easily notice that all of them, except U.S. Pat. No. 4,200,860 (providing blinking capability of the green light, but not the yellow light), compel the driver to split his/her attention between the color light currently lit and a display means set aside of the traffic light that may negatively affect the safety of driving.

The third problem is concerned to the person's perception ability. Most of the enumerated herein above inventions do not provide a clear indication of the remaining light time in the easily comprehended form of number of seconds, except those utilizing numerical displays (U.S. 2002/0005790 A1 and U.S. Pat. No. 6,268,805 B1). In whole, there is no single method or device, solving all these three problems in one combination: displaying the yellow light remaining time; displaying the remaining time within the face of the yellow light display; and displaying the remaining time in the form of numerals respective to the number of seconds left to the end of the yellow light signal.

It is therefore an aim of the invention to provide a novel and useful traffic light device and method of traffic control incorporating all three above mentioned solutions in one combination.

This aim is achieved by providing a traffic light device, comprising a yellow light display capable to advise the motorist on the time remaining to the end of the yellow signal, and accordingly to the beginning of the red signal, in the form of numerals, displayed on the face of said yellow light display, which numerals are corresponding to the number of seconds left to the end of the yellow signal. Such capability is provided by connecting the yellow light display to a countdown unit controlling the sequential displaying of said numerals. A general switching control device controls the countdown unit, additionally supplying to the countdown unit signals specifying the time period during which the yellow light must be displayed. Its traffic light device's capability increases safety of driving, and may save people's lives and health.

Other aims of the invention will become apparent from a consideration of the drawings, ensuing description, and claims as hereinafter related.

### BRIEF DESCRIPTION OF THE DRAWINGS

FIG. 1 is a general view of an embodiment of the traffic light device in reference to the present invention.

FIG. 2 is a schematic view of two monochromatic displays of the traffic light device with control means, according to an embodiment of the traffic light device in reference to the present invention.

### DESCRIPTION OF THE PREFERRED EMBODIMENT

While the invention may be susceptible to embodiment in different forms, there is shown in the drawings, and will be described in detail herein, specific embodiments of the present invention, with the understanding that the present disclosure is to be considered an exemplification of the principles of the invention, and is not intended to limit the invention to that as illustrated and described herein.

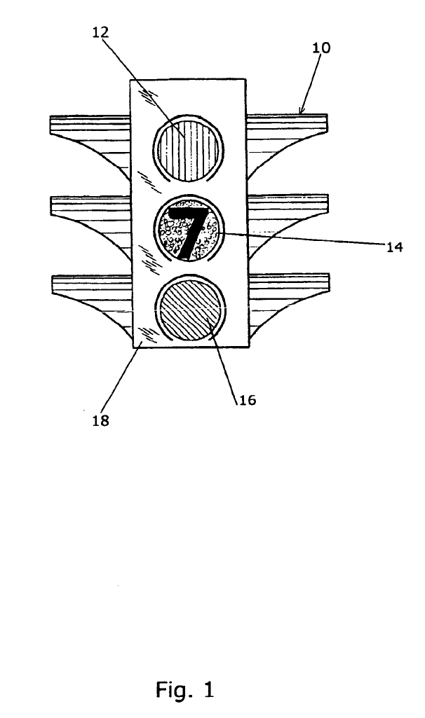

A traffic light in accordance with an embodiment of the present invention is identified with reference numeral 10, illustrated on FIG. 1. The traffic light 10 comprises a casing 18 and three monochromatic color light displays assembled and disposed in the casing 18, for example, vertically above each other as shown. Each such display is correspondingly identified with reference numerals 12, 14 and 16 respectively for exhibiting a red signal, a yellow signal, and a green signal. The display 12, 14, 16 could be provided with protecting transparent cover discs (not shown). Then the displays 12, 14, 16 would be located behind the discs, so that when a corresponding display is turned on, light passes through the corresponding cover disk and a corresponding color signal appears, such as the green signal, the yellow signal, and the red signal. The cover discs may be performed in the form of a convex optical lens to properly collect and direct the passing light.

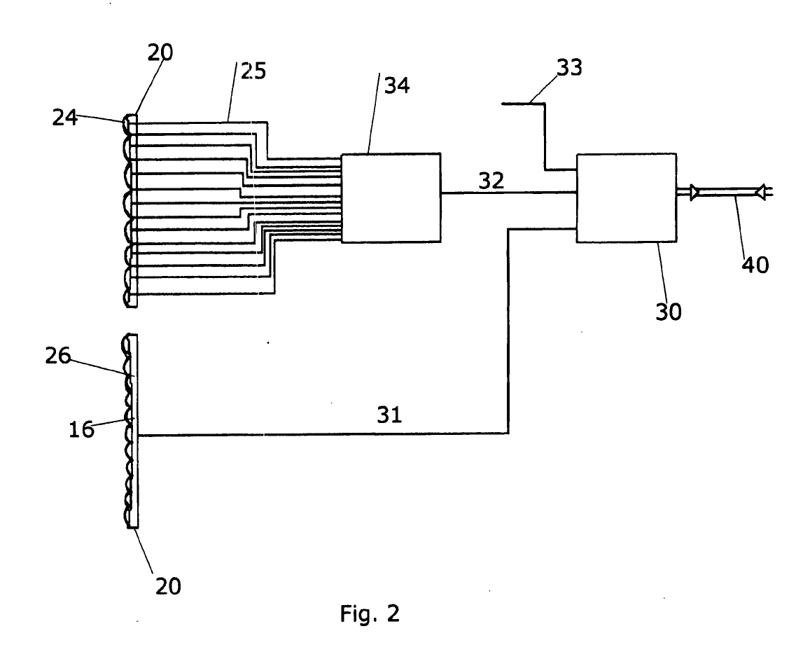

FIG. 2 depicts a sample embodiment of the traffic light in accordance with the present invention, wherein the green light display 16 and the yellow light display 14 are schematically shown. The display 16 comprises a concave fixture 20, which surface may be mirrored for concentration and reflection of light. A number of green light sources 26 are mounted on the fixture 20 substantially covering its concave surface or a part thereof. The red signal display 12 may have a construction (not shown herein) similar to the one of display 16. The green and red light sources may be performed in the form of LEDs.

The display 14 comprises a similar concave fixture 20 with a number of yellow light sources 24 mounted on the fixture 20 substantially covering its concave surface or a part thereof The yellow light sources 24 each may be performed in the form of at least one monochromatic yellow LED. All the yellow light sources 24 are arranged in a matrix for convenient addressing of each or some of individual yellow light sources, thereby allowing the display 14 to display numerals on its face.

The traffic light, in accordance with the present invention, comprises a control device 30, illustrated on FIG. 2. The construction of such a control device is generally well known to a person skilled in the art, does not require additional explanation, and is not part of the present invention. The control device 30 controls the on/off switching of the displays 12, 14, 16, and is connected to a street traffic control system through a wiring 40. The street traffic control system may send commands to the control device 30, for example, alternating the lit time periods of the green, yellow, and red lights according to changing road traffic, or other conditions. In this embodiment the control device 30 is connected to the green light sources 26 through a wiring 31 and to the red light sources of display 12 (not shown on FIG. 2) through a wiring 33. Thus, the green light sources 26 (as well as the red light sources) of this embodiment lit all at the same time, when commutated to a power source by the control device 30.

The traffic light, in accordance with the present invention, comprises a countdown communication unit 34, illustrated on FIG. 2. The countdown unit 34 is configured to be capable of addressing each or some of the individual yellow light sources 24, thereby enabling the display 14 to display numerals on its face, for example in the sequential order from 5 to 1. The individual yellow light sources 24 are connected to the countdown unit 34 through a wiring 25 allowing to address each such individual yellow light sources 24 and illuminate it according to a signal transmitted by the countdown unit 34. The countdown unit 34 is connected to the control device 30 by a wiring 32. The unit 34 receives the on/off commands and signals, specifying the time period during which the yellow light must be displayed, from the control device 30. This time period may be determined empirically for particular intersections and conditions.

When the unit 34 receives the off command, it switches off. On the other hand, when it receives the on command (starting the yellow light on the display 14), it also receives from the control device 30 a signal specifying the time period during which the yellow light must be displayed. Then the countdown unit 34 initiates the countdown process, transforming the time signal into a sequence of numerals and controlling the display 14 to successively display the numerals according to the number of seconds remaining to the end of said specified time period.

The desirable mode of displaying said numerals, presently known to applicant, is by illuminating the individual yellow light sources surrounding the numeral intended for display. This is shown on the face of yellow display 14 forming a dark number “7” on the illuminated background, illustrated on FIG. 1. This mode allows to keep the illumination level of the yellow light display sufficient for viewing by not only the drivers positioned near to the intersection, but also by the remote drivers positioned far enough from the intersection.

An example of use of the inventive traffic light device follows. A driver, thinking about his difficult family situation, approaches an intersection, and suddenly sees that the traffic light is switched from the green to the yellow light. He is positioned close enough to the intersection, and decides not to take a risk of proceeding into the intersection (i.e. makes his clear-stop decision). Thus, he now needs to make a fast how-to-stop decision. On the yellow light display of the traffic light he sees the number of seconds left until the red light will be on, for example, 3 seconds. He also realizes that his distance to the intersection line is sufficient to make a smooth stop, and decelerates the vehicle accordingly. There is no need to make an abrupt stop, thereby subjecting himself and the motorists behind him to a danger of possible collision of his and their vehicles. If, for example, only 1 second were left, the braking process would be more intensive. The behind following motorists would also see the 1 remaining second and probably would also make a fast stop.

As a result, the additional “remaining time” information is provided for drivers to help them decide how fast to stop at the yellow signal. It is believed that this increases the safety of driving.

In other embodiments, the yellow light display, exhibiting said countdown numerals, may be combined with the green (and/or red) light display also similarly enabled for such exhibiting of the number of seconds remaining until the end of the green (or red) signal. Alternatively, it can be combined with the green light enabled to flush, as described above in the respective prior art patents.

Also, the yellow light display may have a different size, e.g. larger than the other two. It should be noticed, that the far remote drivers generally do not need to see the displayed “yellow” seconds, since they are unlikely in a position to make a how-to-stop decision related to the traffic light changes. The closely positioned drivers should be able to see the displayed numerals on the yellow display of a regular size.

The inventive traffic light may be embodied in a traditional form, having colored transparent discs and regular light sources (lamps, fluorescent tubes, and other similar conventionally known devices) disposed behind them. The light sources of the yellow light display should be suitable to create a matrix, so that at least some of them can be individually addressed by a similar countdown unit to properly display said numerals.

The control device 30 and countdown unit 34 may be incorporated into the case 18, or can be installed separately. In such a case, the wiring connections 25, 31, 32, 33 may be alternatively implemented wirelessly, whereas a power source can be embedded in the casing 18.

It will be understood that each of the elements described above, or two or more together may also find a useful application in other types of constructions and methods differing from the types described above.

While the invention has been illustrated and described as embodied in a traffic light, is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. A traffic light device, improving safety of driving, comprising:
a yellow light display means operable for illumination within a predetermined time period, and capable to display on its face numerals corresponding to the number of seconds remaining to the end of said predetermined time period.

2. A traffic light device, improving safety of driving, comprising:
a green light display means capable to be switched on and lit within a predetermined time, and thereafter to be switched off;
a yellow light display means capable to be switched on, immediately after the greed light display means switched off and lit within a predetermined time, and thereafter to be switched off;
a red light display means capable to be switched on, immediately after the yellow light display means switched off, lit within a predetermined time, and thereafter to be switched off, and allowing the green light display means to be switched on, immediately after said red light display means switched off;
a countdown means configured to provide display of numerals on the face of the yellow light display means, wherein said numerals corresponding to the number of seconds remaining to the end of said predetermined time within which the yellow light display means being lit.

3. The traffic light device according to claim 2, wherein
the yellow light display means comprising a plurality of individual light sources capable to be illuminated independently of each other.

4. The traffic light device according to claim 3, wherein
said numerals preferably displayed by illuminating the individual light sources surrounding the numeral intended for display, so that the numeral displayed in dark, whereas the displayed background illuminated.

5. The traffic light device according to claim 3, wherein
said individual light sources performed as monochromatic yellow light emitting diodes.

6. The traffic light device according to claim 3, wherein at least one of the green light display and the red light display comprising a plurality of individual light sources capable to be illuminated independently of each other.

7. The traffic light device according to claim 6, wherein
said individual light sources performed as monochromatic light emitting diodes of a corresponding color.

8. The traffic light device according to claim 6, further comprising:
countdown means configured to provide display of numerals on the face of at least one of the green light display means and the red light display means, wherein the numerals corresponding to the number of seconds remaining to the end of the respective predetermined time within which the green light display means or the red light display means being lit.

9. The traffic light device according to claim 3, wherein
said individual light sources mounted on a concave mirrored fixture.

10. The traffic light device according to claim 6, wherein
said individual light sources mounted on a concave mirrored fixture.

11. The traffic light device according to claim 3, wherein
said individual light sources covered by a transparent disc.

12. The traffic light device according to claim 6, wherein
said individual light sources covered by a transparent disc.

13. The traffic light device according to claim 11, wherein
said transparent disc performed as a convex lens.

14. The traffic light device according to claim 12, wherein
said transparent disc performed as a convex lens.

15. A method of traffic control with a traffic light comprising the acts of:
providing a yellow light display means of the traffic light;
specifying the switch on and off conditions defining a predetermined time period for illumination of the yellow light display means;
transforming the predetermined time period into a sequence of numerals corresponding to the number of seconds remaining to the end of said predetermined time period;
exhibiting said sequence of numerals on the face of the yellow light display means simultaneously with the illumination of the yellow light display means during said predetermined time period.
